(19) United States
(12) Patent Application Publication
(10) Pub. No.: US 2009/0041063 A1
(43) Pub. Date: Feb. 12, 2009

(54) FIBER LASER APPARATUS

(75) Inventor: Manabu SAITOU, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujikura Ltd., Tokyo (JP)

(21) Appl. No.: 12/100,720

(22) Filed: Apr. 10, 2008

(30) Foreign Application Priority Data
Apr. 10, 2007 (JP) 2007-102524

(51) Int. Cl. H01S 3/067

(52) U.S. Cl. 372/6

(57) ABSTRACT

In a fiber laser apparatus that uses a rare earth added fiber as a light amplifying medium of a resonator or amplifier, the rare earth added fiber is a photonic bandgap fiber in which a rare earth element has been added to a core. Moreover, the loss when the rare earth element absorption portion is excluded from the transmission loss in this photonic bandgap fiber is such that the transmission loss in the wavelength of primary Stokes light that is generated by induced Raman scattering is greater than the transmission loss in the wavelength of light that is output by the fiber laser apparatus. According to the present invention, it is possible to provide a fiber laser apparatus that suppresses the generation of Raman light created by induced Raman scattering, and suppresses the amplification of secondary Stokes light, and is able to efficiently amplify the power of the signal light that is the amplification target.

### BACKGROUND OF THE INVENTION

1. Field of the Invention

The present invention relates to a fiber laser apparatus that is capable of performing high output pulse oscillation, and particularly to technology that suppresses any reduction in the efficiency of a fiber laser output that is due to the occurrence of induced Raman light scattering.

Priority is claimed on Japanese Patent Application No. 2007-102524, filed Apr. 10, 2007, the contents of which are incorporated herein by reference.

2. Description of Related Art

In optical communication, when induced Raman scattering occurs, this creates noise in wavelength division multiplexing, and the problem also arises that there is a reduction in excitation light energy. Conventional methods of suppressing induced Raman scattering are the technologies described in, for example, Japanese Patent Application, Publication Nos. 61-107325, 62-196629, and 2002-6348, and in M. E. Fermann, “Single mode excitation of a multimode fiber amplifier”, Optics letters, 23(1), 52-54, 1998, J. P. Koplow, “Single-mode operation of a coiled multimode fiber amplifier”, Optics letters, 25(7), 424-444, 2000

In recent years, fiber lasers that use rare earth doped fibers have been put to practical use and are attracting attention. Fiber laser outputs are becoming increasingly larger in order to respond to the needs of high power lasers.

However, in a fiber laser, when the optical power is increased, then the influence of non-linear effect is also increased. In case of the pulse fiber laser, because the power of the propagated light is of a far greater magnitude, namely, is 10 W or more on average, and has a peak of 10 kW, compared to the optical power used in optical communication, the conventional measures used to counter induced Raman scattering are insufficient and new counter measures are required.

Raman light that occurs inside the fiber laser due to induced Raman scattering absorbs energy from excitation light and is amplified. As a result, the problem exists that it is impossible to increase the power of the light that originally was to be amplified.

For this reason, it is essential to avoid the generation of Raman light caused by induced Raman scattering as far as possible, and when it does occur, to prevent it from being propagated inside the optical fiber.

The wavelength of the light that is generated by induced Raman scattering is longer compared to the wavelength of the light that was originally to have been amplified and output. Typically, the propagation loss of an optical fiber in the near infrared region is as low as the long wavelength side. Because of this, particularly on the long wavelength side, the problem exists that induced Raman light is easily generated and this light is easily propagated.

Furthermore, a method may also be considered in which loss on the long wavelength side is increased by bending the optical fiber, however, in this case, because the wavelength of the Raman light that is generated by induced Raman scattering is not very far from the wavelength of the signal light, the problem exists that the signal light are also being attenuated.

Moreover, in the conventional technologies disclosed in the above described documents, the following problems exist.

In the conventional technology disclosed in Japanese Patent Application, Publication No. 61-107325, the structure is complicated compared with that of the standard optical fiber, and there is a tendency for optical loss to increase. Furthermore, in the large output fiber laser, the problem exists that optical loss causes a large amount of heat generation.

In the conventional technology disclosed in Japanese Patent Application, Publication No. 62-196629, the case in which the light is propagated for a fairly long distance is assumed. However, in case of strong light such as that in the fiber laser, because induced Raman scattering is generated over a distance of approximately 20 m, this conventional technology is ineffective.

In the conventional technology disclosed in Japanese Patent Application, Publication No. 2002-6348, because a filter is used along the fiber, loss is considerable, and there is a strong possibility of damage occurring in the case of high power light such as that of a fiber laser.

Furthermore, one general problem in the conventional technology lies in the fact that, when a filter portion is determined, the cutoff wavelength is also being determined. Consequently, in cases when the signal light source and optical fiber characteristics are changed slightly, or when there are variations therein due to manufacturing irregularities, then the filter needs to be changed in order to deal with such occurrences.

The present invention was conceived in view of the above described circumstances, and it is an object thereof to provide a fiber laser apparatus that suppresses the generation of Raman light created by induced Raman scattering, and suppresses the amplification of secondary Stokes ray, and is able to efficiently amplify the power of the signal light that is the amplification target.

### SUMMARY OF THE INVENTION

In order to achieve the above described objects, the present invention provides a fiber laser apparatus that uses a rare earth added fiber as a light amplifying medium of a resonator or amplifier, wherein the rare earth added fiber is a photonic bandgap fiber in which a rare earth element has been added to a core, and, in the fiber, a loss when a rare earth element absorption portion is excluded from the transmission loss in the wavelength of light that is output by the fiber laser apparatus is smaller than a loss when the rare earth element absorption portion is excluded from the transmission loss in the wavelength of primary Stokes light that is generated in the fiber laser apparatus by induced Raman scattering.

In addition, the present invention provides a fiber laser apparatus that uses a rare earth added fiber as a light amplifying medium of a resonator or amplifier, wherein the rare earth added fiber is a photonic bandgap fiber in which a rare earth element has been added to a core, and, in the fiber, a loss when a rare earth element absorption portion is excluded from the transmission loss in the wavelength of primary Stokes light that is output by the fiber laser apparatus is smaller than a loss when the rare earth element absorption portion is excluded from the transmission loss in the wavelength of secondary Stokes light that is generated in the fiber laser apparatus by induced Raman scattering.

In the fiber laser apparatus of the present invention, it is desirable for the loss when a rare earth element absorption portion is excluded from the transmission loss in the wavelength of light that is output by the fiber laser apparatus to be smaller by 10 dB/m or greater than a loss when the rare earth element absorption portion is excluded from the transmission loss in the wavelength of primary Stokes light that is generated in the fiber laser apparatus by induced Raman scattering.

In the fiber laser apparatus of the present invention, it is desirable for the loss when the rare earth element absorption portion is excluded from the transmission loss in the wavelength of primary Stokes light that is output by the fiber laser apparatus to be smaller by 10 dB/m or more than the loss when the rare earth element absorption portion is excluded from the transmission loss in the wavelength of secondary Stokes light that is generated in the fiber laser apparatus by induced Raman scattering.

In the fiber laser apparatus of the present invention, it is preferable for the loss per unit length of the rare earth added fiber in the wavelength of primary Stokes light to be larger than the gain per unit length therein.

In the fiber laser apparatus of the present invention, it is preferable for the loss per unit length of the rare earth added fiber in the wavelength of secondary Stokes light to be larger than the gain per unit length therein.

In the fiber laser apparatus of the present invention, it is preferable for the rare earth added fiber to have a cutoff wavelength adjustment portion where a bend diameter of the fiber is suitably changed such that a desired cutoff wavelength for signal light of different wavelengths can be obtained.

The fiber laser apparatus of the present invention uses a photonic bandgap fiber in which a rare earth element has been added to the core as a light amplifying medium of a resonator or amplifier. Moreover, this photonic bandgap fiber has transmission characteristics in which the transmission loss in the wavelength of primary Stokes light that is generated by induced Raman scattering is greater than the transmission in the wavelength of light that is output by the fiber laser apparatus, or alternatively, in which the transmission loss in the wavelength of secondary Stokes light that is generated by induced Raman scattering is greater than the transmission loss in the wavelength of primary Stokes light that is output by the fiber laser apparatus. As a result, it is possible to suppress the generation of Raman light created by induced Raman scattering, and also suppress the amplification of secondary Stokes light, and to efficiently amplify the power of the signal light that is the amplification target.

Furthermore, it is possible to easily change the cutoff wavelength by appropriately modifying the bend diameter of the photonic bandgap fiber. As a result, even if there is a small change in the amplification characteristics of a signal light source or photonic bandgap fiber, and there is a shift in the wavelength to be cut off, it is possible for this to be dealt with easily.

### BRIEF DESCRIPTION OF THE DRAWINGS

FIG. 1A is a schematic cross-sectional view of a photonic bandgap fiber, and shows an embodiment of a photonic bandgap fiber that is used as an optical amplifying medium in the fiber laser apparatus of the present invention.

FIG. 1B is an enlarged view of the photonic bandgap portion in FIG. 1A, and shows an embodiment of a photonic bandgap fiber that is used as an optical amplifying medium in the fiber laser apparatus of the present invention.

FIG. 2 is a graph showing an example of loss wavelength characteristics when a rare earth element absorption portion is excluded from the transmission loss in the photonic bandgap fiber shown in FIG. 1A.

FIG. 3 is a graph showing an example of changes in the loss wavelength characteristics when a rare earth element absorption portion is excluded from the transmission loss in the photonic bandgap fiber when a bend is imparted having a predetermined bend diameter to the photonic bandgap fiber shown in FIG. 1A.

FIG. 4 is a schematic view showing an embodiment of the fiber laser apparatus of the present invention.

FIG. 5 is a graph showing wavelength spectrums of output light of fiber laser apparatuses manufactured in example 1 and Comparative example 1.

### DETAILED DESCRIPTION OF THE PREFERRED EMBODIMENTS

Embodiments of the fiber laser apparatus of the present invention are described below with reference made to the drawings.

The fiber laser apparatus of the present invention uses as a light amplifying medium of a resonator or amplifier a photonic bandgap fiber to whose core a rare earth element has been added. In addition, this photonic bandgap fiber has transmission characteristics in which transmission loss in the wavelength of the primary Stokes light that is generated by induced Raman scattering is greater than the transmission loss in the wavelength of the light that is output by the fiber laser apparatus, or alternatively, in which transmission loss in the wavelength of the secondary Stokes light that is generated by induced Raman scattering is greater than the transmission loss in the wavelength of the primary Stokes light that is output by the fiber laser apparatus.

Embodiments of the photonic bandgap fiber that is used in the fiber laser apparatus of the present invention include photonic bandgap fibers having a triangular lattice structure, a honeycomb structure, or a concentric circular structure.

Moreover, favorable parameters for this photonic bandgap fiber include a photonic bandgap layer number of between 2 and 10 layers, a core diameter of approximately 20 to 30 μm, a relative index difference of the high refractive index portions relative to the cladding of approximately 0.5%, and a relative index difference of the core relative to the cladding of approximately −0.2 to 0.2%.

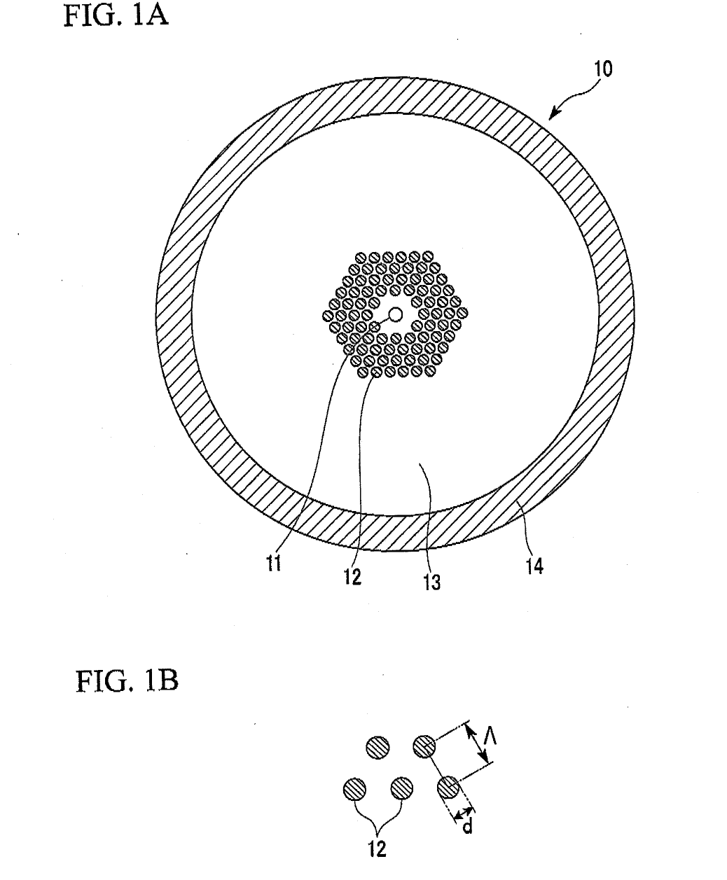

FIGS. 1A and 1B show an embodiment of a photonic bandgap fiber that is used as a light amplifying medium in the fiber laser apparatus of the present invention. FIG. 1A is a schematic cross-sectional view of a photonic bandgap fiber 10, while FIG. 1B is an enlarged view of the photonic bandgap portion thereof.

This photonic bandgap fiber 10 is formed by a core 11 that is made of quartz glass to which one or two or more rare earth elements such as, for example, ytterbium, erbium, thulium and the like have been added, a first cladding 13 that is made of quartz glass and encircles the core 11, a photonic gap portion that encircles the core 11 via one or a plurality of intervals in an area on the core side of the first cladding 13, and in which a large number of high refractive index portions 12 that have a small, circular cross section are arranged in a plurality of layers in a triangular lattice shape, and a second cladding 14 that is made of a low refractive index polymer such as a fluorine based ultraviolet ray curable resin and encircles the first cladding 13. As is shown in FIG. 1B, this photonic band gap portion has a structure in which the large number of high refractive index portions 12 which have a diameter d are arranged in a triangular lattice at a uniform pitch Λ.

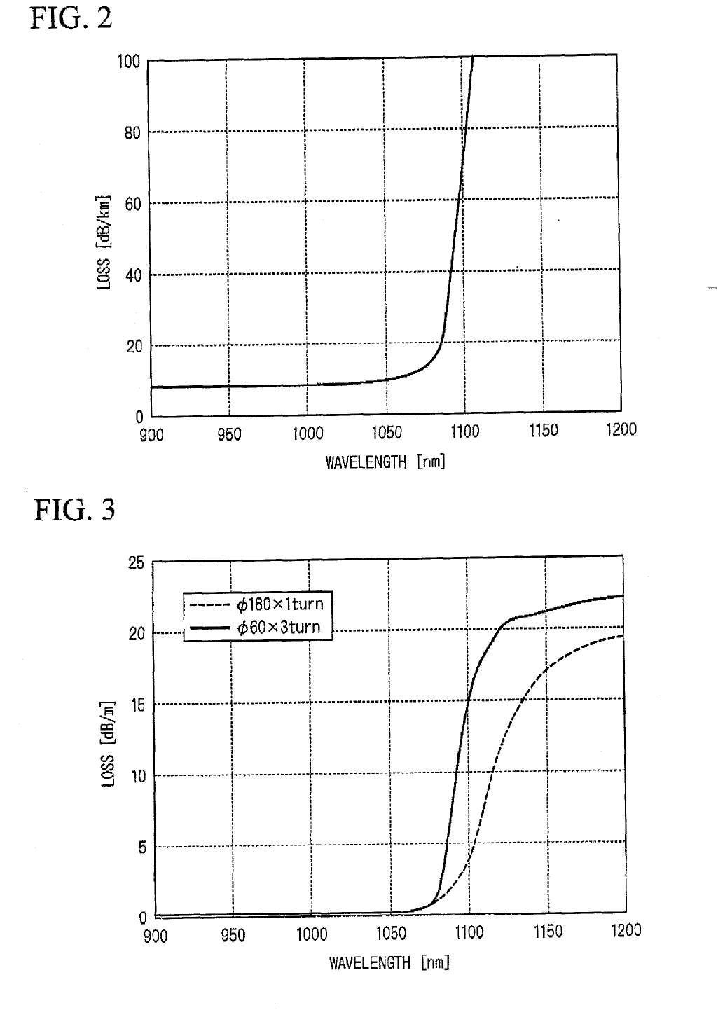

FIG. 2 is a graph showing an example of loss wavelength characteristics when a rare earth element absorption portion is excluded from the transmission loss in this photonic bandgap fiber 10. As is shown in FIG. 2, in the photonic bandgap fiber 10 of this example, when the wavelength changes to a longer wavelength than one in the vicinity of 1090 nm, there is an abrupt increase in loss. As is described above, because the wavelength of light that is created by induced Raman scattering is longer than the wavelength of the light that was originally amplified and should have been output, if the wavelength of the signal light that was originally amplified and output is set to 1090 nm or less, then the light that is generated by induced Raman scattering (i.e., primary or secondary Stokes light) is not propagated through this photonic bandgap fiber 10 and can be cut off.

Here, a wavelength in which there is an abrupt increase in loss can be changed by appropriately modifying the relative index difference, the diameter, the pitch and the like of the high refractive index portion of the photonic bandgap fiber. Because of this, even if there is a change in the wavelength of the light that was to have been output, this can be dealt with by modifying the design of the photonic bandgap fiber.

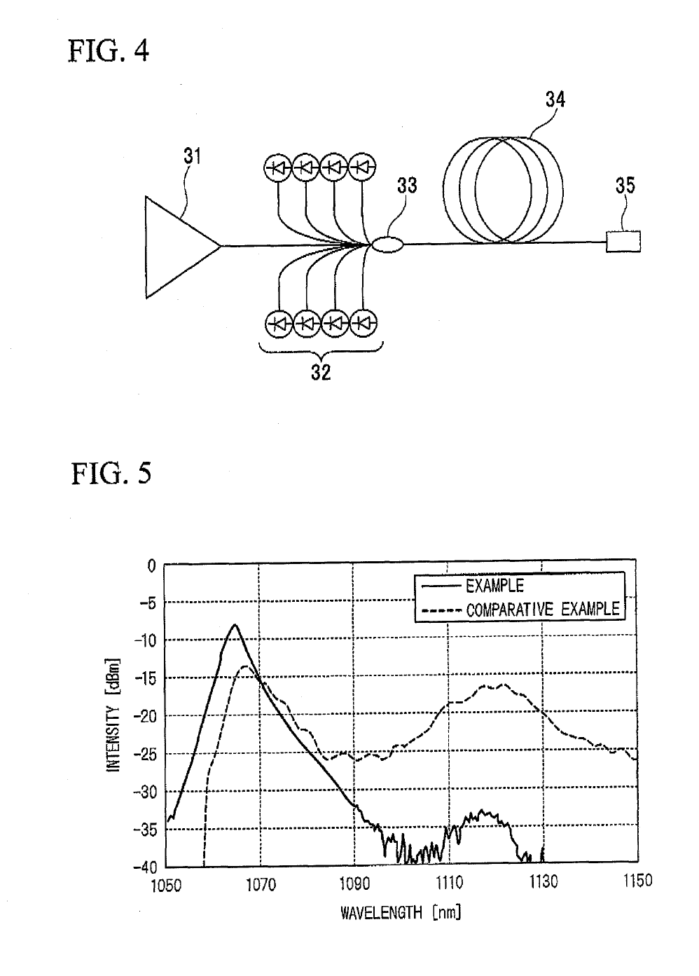

FIG. 4 is a structural view showing an embodiment of the fiber laser apparatus of the present invention. The fiber laser apparatus in this example is formed by a pulse light generating portion 31, a plurality of excitation light sources 32 (referred to below as excitation LD) such as laser diodes (LD), a multi-port combiner 33 that allows pulse light (i.e., signal light) from the pulse light generating portion 31 and excitation light from the excitation LD 32 to be irradiated into an amplifying fiber 34, the amplifying fiber 34 that is formed by a photonic bandgap fiber having a core to which rare earth elements have been added and having the cross-sectional structure shown in FIG. 1, and an output portion 35 that is provided on an output side of the amplifying fiber 34.

In the fiber laser apparatus of this embodiment, the multi-port combiner 33 is connected such that pulse light from the pulse light generating portion 31 is irradiated into the core of the amplifying fiber 34, and such that excitation light from the excitation LD 32 is irradiated into the first cladding of the amplifying fiber 34. Excitation light that is irradiated into the amplifying fiber 34 through the multi-port combiner 33 excites rare earth ions that have been added to the core as it is propagated through the interior of the amplifying fiber 34, and pulse light that has been irradiated into the core is amplified by the excited rare earth ions, and this amplified light is output from the output portion 35.

In the laser fiber apparatus of this embodiment, a photonic bandgap fiber having the structure shown in FIGS. 1A and 1B and having a core to which rare earth elements have been added is used as the amplifying fiber 34, and this amplifying fiber 34 has transmission characteristics in which transmission loss in the wavelength of the primary Stokes light that is generated by induced Raman scattering is greater than the transmission loss in the wavelength of the light that is output by the fiber laser apparatus, or alternatively, in which transmission loss in the wavelength of the secondary Stokes light that is generated by induced Raman scattering is greater than the transmission loss in the wavelength of the primary Stokes light that is output by the fiber laser apparatus. Because of this, it is possible to suppress the generation of Raman light created by induced Raman scattering, and suppress the amplification of secondary Stokes light, and efficiently amplify the power of the signal light that is the amplification target.

Furthermore, by using a photonic bandgap fiber having a structure such as that shown in FIGS. 1A and 1B, it is possible to easily change the cutoff wavelength by appropriately modifying the bend diameter of the photonic bandgap fiber.

FIG. 3 is a graph showing an example of changes in the loss wavelength characteristics when a rare earth element absorption portion is excluded from the transmission loss when a bend is imparted at a predetermined bend diameter (i.e., φ 180 mm×1 turn and φ 60 mm×3 turns) to a photonic bandgap fiber having the structure shown in FIGS. 1A and 1B. As is shown in FIG. 3, by altering the bend diameter and the number of turns that are used for the photonic bandgap fiber 10, it is possible to easily modify by approximately 20 nm the wavelength that functions as a filter without changing the base line loss, as is the case when a bend is applied to a normal fiber. Because of this, even if there is a small change in the amplification characteristics of a signal light source or rare earth fiber, and there is a shift in the wavelength to be cut off, it is possible for this to be dealt with easily.

Note that the phrase ‘loss when the rare earth element absorption portion is excluded from the transmission loss in the photonic bandgap fiber’ corresponds to ‘transmission loss when a rare earth element is not added to the core of a photonic bandgap fiber’. Accordingly, in the present invention, it is possible to replace the phrase ‘loss when the rare earth element absorption portion is excluded from the transmission loss in the photonic bandgap fiber’ with the phrase ‘transmission loss when a rare earth element is not added to the core of a photonic bandgap fiber’.

### EXAMPLES

### Example 1 and Comparative Example 1

Using the structure shown in FIG. 4, the fiber laser apparatus of the present invention that uses the photonic bandgap fiber 10 having the structure shown in FIGS. 1A and 1B as the amplifying fiber 34 (Example 1), and a fiber laser apparatus that uses a normal rare earth added fiber as the amplifying fiber 34 (Comparative example 1) were manufactured, and the outputs from both apparatuses were compared.

In the fiber laser apparatuses of Example 1 and Comparative example 1, the wavelength of the light that is output by the fiber laser apparatuses is 1065 nm, and the wavelength of the primary Stokes light that is generated by induced Raman scattering is 1120 nm.

The photonic bandgap fiber 10 used in Example 1 is formed by a core 11 that has a diameter of 20 μm and is made of quartz glass to which 10,000 ppm by mass of ytterbium have been added, a first cladding 13 that has an outer diameter of 400 μm and is made of pure quartz glass, a photonic gap portion in which a large number of high refractive index portions 12 are arranged in a triangular lattice shape in four layers in the first cladding 13 in the vicinity of the core, and a second cladding 14 that is made of a fluorine based ultraviolet ray curable resin and encircles the first cladding 13. The outer diameter of the second cladding is 500 μm. The relative index difference of the core 11 relative to the first cladding 12 was set at 0%, the relative index difference of the high refractive index portions 12 relative to the core 11 was set at 1.6%, and the relative index difference of the second cladding 14 relative to the core 11 was set at −5%. Moreover, in the photonic bandgap portion, the pitch Λ between the high refractive index portions 12 shown in FIG. 1B was set at 8.5 μm, and the diameter d of the high refractive index portions 12 was set at 1.7 μm.

The loss when the rare earth element absorption portion was excluded from the transmission loss in the 1065 nm wavelength was 0.01 dB, while the loss when the rare earth element absorption portion was excluded from the transmission loss in the 1120 nm wavelength was 10.6 dB.

The rare earth added fiber used in Comparative example 1 was formed without the photonic bandgap portion being provided by a core that has a diameter of 20 μm and is made of quartz glass to which 10,000 ppm by mass of ytterbium have been added, a first cladding that has an outer diameter of 400 μm and is made of pure quartz glass, and a second cladding that is made of a fluorine based ultraviolet ray curable resin and encircles the first cladding. The outer diameter of the second cladding is 500 μm. The relative index difference of the core relative to the first cladding was set at 0.13%, and the relative index difference of the second cladding relative to the core was set at −5%.

Light from the pulse light generating portion 13 was set as pulse light having a repetition frequency of 20 kHz, a peak intensity of 50 W, a pulse width of 80 ns, and a central wavelength of 1065 nm, while the excitation light from the excitation LD 32 was set at a total of 40 W. The lengths of the amplifying fibers 34 were set respectively at 15 m, while the distance from the multi-port combiner 33 to the output portion 35 was set at 25 m.

In addition, the loss wavelength characteristics of a fiber that was manufactured having the same structure as the photonic bandgap fiber used in Example 1, but whose core had not been doped with ytterbium were checked. As a result, as is shown in FIG. 2, the loss wavelength characteristics showed an abrupt increase in loss on the long wavelength side of the vicinity of the 1090 nm wavelength.

The outputs from the fiber laser apparatuses averaged 16 W in both Example 1 and Comparative example 1. However, when the wavelength spectrums thereof were compared, as is shown in FIG. 5, it was found that while, in the Example, almost all of the light was in the vicinity of 1065 nm, which is the signal light wavelength, in the Comparative example, the amount of light that was in the 1120 mn vicinity due to induced Raman scattering was large, and light in the signal light wavelength which is the amplification target was reduced to approximately ¼th (i.e., −6 dB).

### Example 2 and Comparative Example 2

In order to narrow the pulse width, a fiber laser apparatus was manufactured in which the light from the pulse generator was set to pulse light of 1020 nm, and primary Stokes light was generated inside the amplifying fiber, and was amplified resulting in 1090 nm output light being obtained. The structure of this apparatus was the same as that shown in FIG. 4, and a fiber laser apparatus of the present invention (Example 2) that uses as the amplifying fiber a photonic bandgap fiber having the structure shown in FIG. 1, and in which the pitch Λ between the high refractive index portions 12 shown in FIG. 1B was set at 8.7 μm, and the diameter d of the high refractive index portions 12 was set at 1.7 μm was manufactured. In addition, a fiber laser apparatus (Comparative example 2) that uses as the amplifying fiber a normal rare earth added fiber was manufactured. The outputs of these two fiber laser apparatuses were then compared.

In the fiber laser apparatuses of Example 2 and Comparative example 2, the wavelength of the primary Stokes light that was output by the fiber laser apparatuses was 1090 nm, and the wavelength of the secondary Stokes light that was generated by induced Raman scattering was 1150 nm.

The loss when the rare earth element absorption portion was excluded from the transmission loss in the 1090 nm wavelength was 0.01 dB, while the loss when the rare earth element absorption portion was excluded from the transmission loss in the 1150 nm wavelength was 11.2 dB.

Light from the pulse generator was set as pulse light having a repetition frequency of 10 kHz, a peak intensity of 180 W, a pulse width of 25 ns, and a central wavelength of 1030 nm, while the excitation light from the excitation LD was set at a total of 50 W. The distance from the multi-port combiner to the output portion was set at 60 m. The amplifying fibers were each doped with ytterbium to the same concentration.

The outputs from the fiber laser apparatuses averaged 20 W in both Example 2 and Comparative example 2. However, when the wavelength spectrums thereof were compared, it was found that while, in Example 2, almost all of the light was in the vicinity of 1090 nm, which is the primary Stokes light wavelength, in the Comparative example, the amount of light that was in the 1150 nm vicinity, which is secondary Stokes light, was large, and light in the signal light wavelength which is the amplification target was reduced to approximately ⅕th (i.e., −7 dB).

### Example 3

Using a light source having a wavelength of 1055 nm as the pulse light source, a fiber laser apparatus of the type described above was manufactured. The same amplifying optical fiber as that described in Example 1 was used.

The wavelength of the Stokes light that was generated by induced Raman scattering was 1110 nm, however, by modifying the bend diameter of the fiber from φ 200 mm to φ 80 mm, it was found that the same effects were obtained.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. A fiber laser apparatus that uses a rare earth added fiber as a light amplifying medium of a resonator or amplifier, wherein
the rare earth added fiber is a photonic bandgap fiber in which a rare earth element has been added to a core, and,
in the fiber,
a loss when a rare earth element absorption portion is excluded from the transmission loss in the wavelength of light that is output by the fiber laser apparatus is smaller than a loss when the rare earth element absorption portion is excluded from the transmission loss in the wavelength of primary Stokes light that is generated in the fiber laser apparatus by induced Raman scattering.

2. A fiber laser apparatus that uses a rare earth added fiber as a light amplifying medium of a resonator or amplifier, wherein
the rare earth added fiber is a photonic bandgap fiber in which a rare earth element has been added to a core, and,
in the fiber,
a loss when a rare earth element absorption portion is excluded from the transmission loss in the wavelength of primary Stokes light that is output by the fiber laser apparatus is smaller than a loss when the rare earth element absorption portion is excluded from the transmission loss in the wavelength of secondary Stokes light that is generated in the fiber laser apparatus by induced Raman scattering.

3. The fiber laser according to claim 1, wherein the loss when the rare earth element absorption portion is excluded from the transmission loss in the wavelength of light that is output by the fiber laser apparatus is smaller by 10 dB/m or more than the loss when the rare earth element absorption portion is excluded from the transmission loss in the wavelength of primary Stokes light that is generated in the fiber laser apparatus by induced Raman scattering.

4. The fiber laser according to claim 2, wherein the loss when the rare earth element absorption portion is excluded from the transmission loss in the wavelength of primary Stokes light that is output by the fiber laser apparatus is smaller by 10 dB/m or more than the loss when the rare earth element absorption portion is excluded from the transmission loss in the wavelength of secondary Stokes light that is generated in the fiber laser apparatus by induced Raman scattering.

5. The fiber laser apparatus according to claim 1, wherein the loss per unit length of the rare earth added fiber in the wavelength of primary Stokes light is larger than the gain per unit length therein.

6. The fiber laser apparatus according to claim 2, wherein the loss per unit length of the rare earth added fiber in the wavelength of secondary Stokes light is larger than the gain per unit length therein.

7. The fiber laser apparatus according to any one of claims 1 through 6, wherein the rare earth added fiber has a cutoff wavelength adjustment portion where a bend diameter of the fiber is suitably changed such that a desired cutoff wavelength for signal light of different wavelengths can be obtained.
